(19) United States
(12) Patent Application Publication
(10) Pub. No.: US 2024/0265264 A1
(43) Pub. Date: Aug. 8, 2024

(54) CONTROLLING COMPUTING DEVICES USING HIERARCHICAL AGENTS

(71) Applicant: DeepMind Technologies Limited, London (GB)

(72) Inventors: Gheorghe Tiberi Comanici, Montreal (CA); Amelia Marita Claudia Glaese, Montreal (CA); Anita Gergely, Montreal (CA); Zafarali Ahmed, Montreal (CA); Tyler Jackson, Montreal (CA); Doina Precup, Côte Saint-Luc (CA)

(21) Appl. No.: 18/105,180

(22) Filed: Feb. 2, 2023

(51) Int. Cl. G06N 3/092; G06N 3/045

(52) U.S. Cl. CPC G06N 3/092; G06N 3/045

(57) ABSTRACT

Methods, systems, and apparatus, including computer programs encoded on computer storage media, for controlling one or more computing devices to perform a task using a hierarchical agent. One of the methods includes receiving an observation characterizing a state of the one or more computing devices at the time step; selecting a gesture class for the time step using a high-level agent; processing a mid-level input using a mid-level agent neural network conditioned on the selected gesture class to generate a mid-level output that comprises parameters that define a gesture from the selected gesture class; processing a low-level input using a low-level agent neural network to generate a policy output that defines a sequence of one or more actions for interacting with the one or more computing devices; and performing the sequence of one or more actions to interact with the one or more computing devices.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations for controlling one or more computing devices to perform a task using a hierarchical agent that includes a high-level agent, a mid-level agent neural network, and a low-level agent neural network.

Particular embodiments of the subject matter described in this specification can be implemented so as to realize one or more of the following advantages.

The described techniques control a computing device to perform a task by exploiting a multi-level hierarchy of agents and agent neural networks. In particular, the system uses a high-level agent to select among gesture classes, a mid-level agent neural network to select gestures, and a low-level agent neural network to execute gestures, allowing for efficient and effective control of the computing device for a variety of tasks. The hierarchical decomposition also provides abstraction for the high-level agent and mid-level agent neural network.

The system also provides temporal abstraction. The agents and agent neural networks can be designed in isolation and can be trained at different stages or using different techniques. For example, the mid-level agent neural network can select among a discrete set of gestures, while the agent can control a computing device that operates with a continuous or otherwise much larger action space.

In a distributed hierarchy, each agent or agent neural network can be independent from each other agent or agent neural network. For example, each agent or agent neural network can be trained using its own training dataset or training system and learning updates can be performed on separate machines, allowing for modularity and flexibility.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 shows an example system for controlling a computing device at a given time step during the performance of an episode of a task.

FIG. 3 is a flow diagram of an example process for performing a sequence of actions.

FIG. 4 is a flow diagram of an example process for training the high-level agent, mid-level agent neural network, and low-level agent neural network to control a computing device to perform a task.

Like reference numbers and designations in the various drawings indicate like elements.

### DETAILED DESCRIPTION

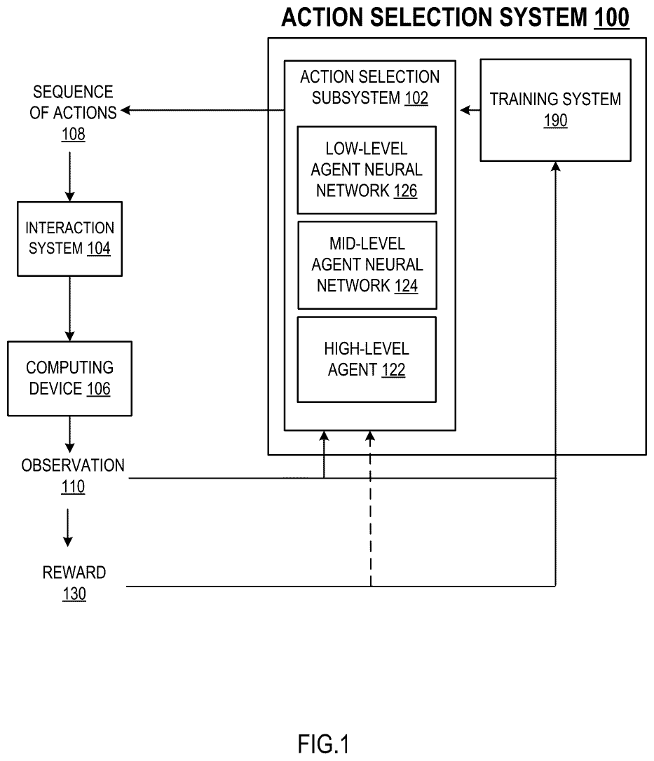

FIG. 1 shows an example action selection system 100. The action selection system 100 is an example of a system implemented as computer programs on one or more computers in one or more locations in which the systems, components, and techniques described below are implemented.

The action selection system 100 controls an interaction system 104 that interacts with a computing device 106 to accomplish a task. In particular, the action selection system 100 selects sequences of actions 108 to be performed by the interaction system 104 at each of multiple time steps during the performance of an episode of the task. For example, the interaction system 104 can include a mechanical agent interacting with a real-world computing device, or a software agent interacting with a real-world computing device. As another example, the interaction system 104 can include a computer interacting with a simulated computing device.

An action is the most basic input that the interaction system 104 can perform on the computing device 106. For example, an action on a display of the computing device can include a touch input at a certain location on the display, or a lift motion at a certain location on the display. As another example, an action on a button of the computing device can include a press or release of the button.

A sequence of actions 108 makes up a gesture. For example, a swipe gesture on a display of the computing device from a start location to an end location involves touch inputs at multiple locations on the screen between the start and end locations.

As a general example, the task can include one or more of, e.g., carrying out activities on a computing device according to voice commands from a user, carrying out activities on a computing device that are specified by a digital assistant application running on the computing device, and so on. For example, activities can include navigating a menu on a display of the computing device, manipulating content on a display of the computing device, and activating tangible inputs such as buttons on the computing device. More generally, the task is specified by received rewards, i.e., such that an episodic return for an episode of a task is maximized when the task is successfully completed during the episode.

An “episode” of a task is a sequence of interactions during which the interaction system attempts to perform a single instance of the task starting from some starting state of the computing device. In other words, each task episode begins with the computing device being in an initial state, e.g., a fixed initial state, a randomly selected initial state, or the state of the computing system when the computing system receives an instruction to perform the task, and ends when the interaction system has successfully completed the task or when some termination criterion is satisfied, e.g., the computing device enters a state that has been designated as a terminal state or the interaction system performs a threshold number of operations without successfully completing the task.

At each time step during any given task episode, the system 100 receives an observation 110 characterizing the current state of the computing device 106 at the time step. In response, the system 100 selects a sequence of actions 108 to be performed by the interaction system 104 at the time step. After the interaction system performs the sequence of actions 108, the computing device 106 transitions into a new state and the system 100 receives another observation 110 from the computing device 106.

In some implementations, the system 100 receives a reward 130 that characterizes performance of the task as of the time step. After the computing device 106 transitions into a new state, the system 100 can receive another reward 130 from the computing device 106.

To control the computing device, at each time step in the episode, an action selection subsystem 102 of the system 100 uses a high-level agent 122, a mid-level agent neural network 124, and a low-level agent neural network 126 to select the sequence of actions 108 that will be performed by the interaction system 104 at the time step. An agent may be implemented as one or more software components configured to receive data and process data from a computing device. For example, the high-level agent 122 can receive and process the observation 110 from the computing device 106. In some implementations, the high-level agent 122 may include a high-level agent neural network.

In particular, the action selection subsystem 102 uses the agent 122 and agent neural networks 124 and 126 to process the observation 110 to generate a policy output that defines a sequence of one or more actions to be performed by the interaction system 104 at the time step.

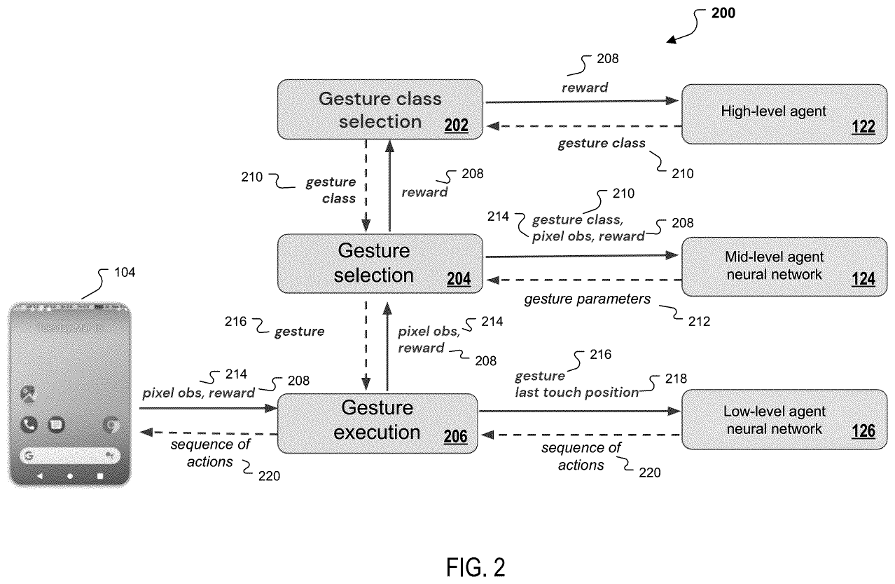

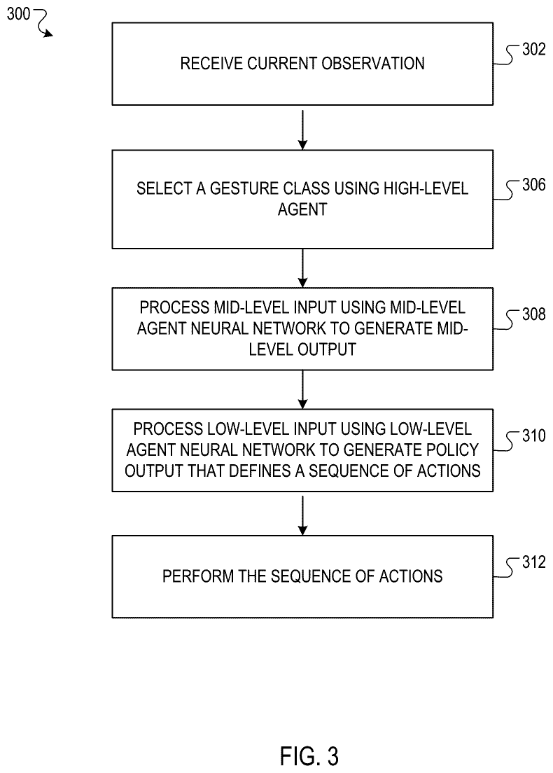

Controlling the computing device at any given time step using the high-level agent 122, the mid-level agent neural network 124, and the low-level agent neural network 126 will be described in more detail below with reference to FIGS. 2 and 3.

Prior to using the agent 122 and agent neural networks 124 and 126 to control the computing device, a training system 190 within the system 100 or another training system can train the agent 122 and agent neural networks 124 and 126.

In particular, the training system 190 can first train the low-level agent neural network 126. The training system 190 can then train the mid-level agent neural network 124 prior to training the high-level agent 122, or jointly train the mid-level agent neural network 124 and high-level agent 122.

The system 100 can receive a reward 130 and provide the reward 130 to the training system 190 for training the high-level agent 122 and the mid-level agent neural network 124.

Generally, the reward 130 is a scalar numerical value and characterizes the progress of the interaction system 104 towards completing the task. The reward is an output of a reward function for the task that maps states of the computing device to reward values that characterize progress towards completing the task. The reward can relate to a metric of performance of the task. For example, in the case of a task that is to navigate a menu on a display of a computing device according to voice commands from a user, the metric can characterize the accuracy of menu navigation according to the commands.

While performing any given task episode, the system 100 selects a sequence of actions at each time step during the episode in order to attempt to maximize a return that is received over the course of the task episode.

That is, at each time step during the episode, the system 100 selects a sequence of actions that attempt to maximize the return that will be received for the remainder of the task episode starting from the time step.

Generally, at any given time step, the return that will be received is a combination, e.g., a sum or a time-discounted sum, of the rewards that will be received at time steps that are after the given time step in the episode.

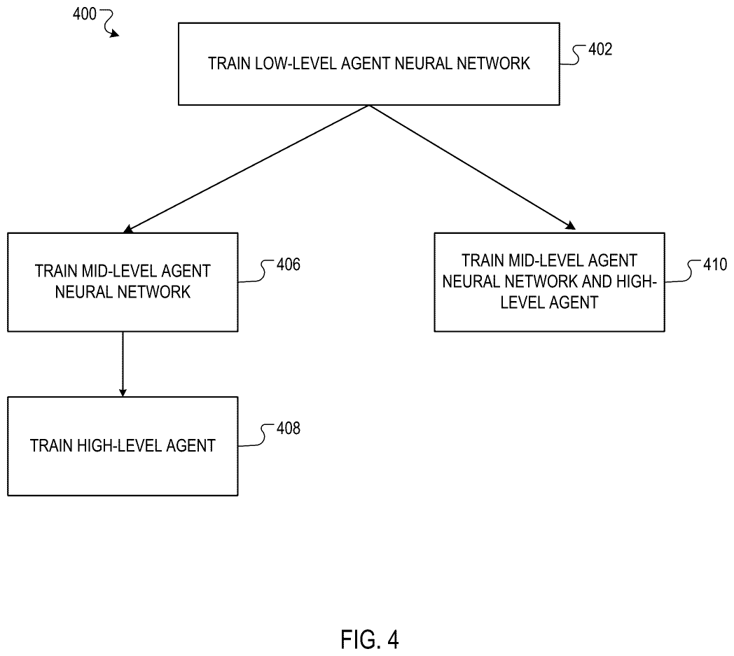

Training is described in more detail below with reference to FIG. 4.

In some implementations, the computing device can be a real-world computing device. In some implementations, the interaction system can include a mechanical agent interacting with the real-world computing device, e.g., a robot operating the real-world computing device. For example, the interaction system can include a robot interacting with a computing device that can be interacted with using touch inputs on a display of the computing device to accomplish a specific task, e.g., navigate a menu on a display of the computing device. In these implementations, the observations can include images of a display of the computing device. The interaction system can convert the sequence of actions into control signals that control the robot or other mechanical agent, e.g., torques for the joints of the robot or higher-level control commands.

In some implementations, the real-world computing device can include physical triggers so that an interaction system can interact with applications and services through inputs to physical triggers on the computing device. For example, a physical trigger can be a button, and an input to the button can be a press of the button. Other examples of physical triggers can be switches, keys, and sensors.

In other implementations, the real-world computing device can include a dedicated input device so that an interaction system can interact with applications and services on the computing device through inputs to the dedicated input device. For example, a dedicated input device can be a mouse pointer, and an input to the mouse pointer can be a press of a button on the mouse. Other examples of dedicated input devices can include keyboards or touch pads.

In some implementations, the interaction system can include a software agent interacting with a real-world computing device, e.g., an application on the computing device that can operate the real-world computing device. For example, the interaction system can include an application interacting with other applications and services on a computing device. In these implementations, the observations can include pixel images corresponding to the display of the computing device. The application can perform the sequence of actions by submitting inputs through software to the computing device that mimic those that can be submitted by a user or a mechanical agent interacting with the real-world computing device. For example, the application can have root access to an operating system on the computing device, and submit inputs to the operating system that appear to the operating system to be touch inputs submitted by a user or a mechanical agent interacting with a display on the computing device.

In some implementations the computing device is a simulation of the above-described real-world computing device, and the interaction system is implemented as one or more computers interacting with the simulated computing device. For example the simulated computing device can include an environment that exposes a simulated display interface of the computing device so that an interaction system can interact with applications and services through simulated touch inputs on the display of the simulated computing device. In these implementations, the observations can include pixel images corresponding to the display of the simulated computing device. In these implementations, the interaction system can convert the sequence of actions into a sequence of programming commands. A programming command corresponding to an action can include a location of the action on the display of the simulated computing device, and a value indicating whether the interaction system wants to interact with the display of the simulated computing device at the location.

In some implementations, the simulated computing device can include an environment that exposes other interfaces of the computing device such as triggers so that an interaction system can interact with applications and services through simulated inputs to triggers on the simulated computing device.

In other implementations, the simulated computing device can include an environment that exposes other interfaces of the computing device such as a dedicated input device so that an interaction system can interact with applications and services through simulated inputs to a dedicated input device. The action selection system 100 can be trained on the simulation and then, once trained, used in the real-world. For example, the action selection system 100 can be trained using an interaction system that is a computer interacting with a simulated computing device. After the action selection system 100 is trained, the action selection system 100 can be used to control an interaction system that includes a mechanical or software agent interacting with a real-world computing device.

FIG. 2 shows an example system 200 for controlling a computing device at a given time step during the performance of an episode of a task. In this example, the system 200 is based on a three-layer hierarchy of agents or agent neural networks 122, 124, and 126, and a three-layer hierarchy of sub-tasks 202, 204, and 206.

The high-level agent 122 performs the sub-task of selecting a single gesture class for the time step, i.e., making a gesture class selection 202. A gesture class defines a type of gesture that can be performed on the computing device. As described above, a gesture is a sequence of actions that can be performed on the computing device and is defined by parameters.

For example, the set of gesture classes can include one or more of a tap gesture class, a swipe gesture class, or a fling gesture class. A tap gesture class includes any possible tap gesture, which is a touch input at a certain location on a display of the computing device followed by a lift motion at the same location. A swipe gesture class includes any possible swipe gesture, which is a touch input that starts at a certain location on a display of the computing device and moves along the display until a lift motion is performed at a different location. A fling gesture class includes any possible fling gesture, which is a touch input on a display of the computing device followed by a slide and lift motion in a certain direction.

The system 200 uses the high-level agent 122 to select a gesture class.

In some implementations, the system 200 selects the gesture class that was determined to be a best performing gesture class for the task during training of the high-level agent 122. For example, during training of the high-level agent 122, the high-level agent 122 can learn a score mapping that maps each gesture class to a score that represents the average per time step reward for the task that was received when gestures from the gesture class were being performed during training episodes. In some implementations, for example if the number of gesture classes is relatively small in number, the high-level agent 122 can use tabular Q-value representations to model the score for each gesture class. The high-level agent 122 can determine the best performing gesture class for the task to be the gesture class that maximizes the score in the score mapping. Thus the system 200 can select the gesture class that was determined to be the best performing gesture class for the task during training of the high-level agent 122, and select this gesture class for each time step in the episode.

In some implementations, the score mapping can map the gesture classes to probability distributions, and the system 200 can select the gesture class for each episode according to the probability distributions, e.g., by sampling a gesture class from the probability distribution at the first time step in the episode and then selecting the sampled gesture class at each time step in the episode.

In some other implementations, the high-level agent 122 can include a high-level agent neural network. The system 200 can process a high-level input derived from an observation characterizing the state of the computing device, “pixel obs” 214, using the high-level agent neural network. In some implementations, the high-level input can also include a reward 208 that characterizes performance of the task as of the time step. The system 200 can use the high-level agent neural network to generate a high-level output that includes a score for each gesture class. For example, the score can represent a predicted return that will be received if a gesture belonging to the gesture class is performed at the time step. The system 200 can select a gesture class from the high-level output. For example, the system 200 can select the gesture class that has the highest score among the gesture classes.

In some implementations, the system 200 can use the high-level agent neural network to select a gesture class (e.g., the system can process a high-level input using the high-level agent neural network, use the high-level agent neural network to generate a high-level output, and select a gesture class from the high-level output) at each time step.

In some other implementations, the system 200 can use the high-level agent neural network to select a gesture class at the beginning of the episode, e.g., at the first time step. The system 200 can select the same gesture class for every remaining time step in the episode.

In yet other implementations, the system 200 can use the high-level agent neural network to select a gesture class at regular intervals during the episode. For example, the system 200 can select a gesture class at the first time step and select the same gesture class for the next n time steps in the interval, where n is an integer greater than or equal to one. The system 200 can repeat the selection of a gesture class at the next time step after each interval.

In some implementations, the system 200 can use the high-level agent neural network to select a gesture class whenever a criterion is satisfied. That is, the system 200 can use the high-level agent neural network to select a gesture class at the first time step, and select the same gesture class for the remaining time steps until the criterion is satisfied. If the criterion is satisfied, the system 200 can use the high-level agent neural network to repeat the selection of a gesture class (that could be the same gesture class or a different gesture class). For example, if the task is to play a game on the computing device, the criterion can be a measure of progress or performance in the game, measured after each time step. If the measure of progress or performance drops below a threshold value, the system 200 can use the high-level agent neural network to select a new gesture class at the next time step.

The high-level agent 124 can be trained on training data for the task that includes rewards such as reward 208. In some implementations, for example where the high-level agent 124 includes a high-level agent neural network, the high-level agent neural network can be trained on training data for the task that also includes observations such as observation 214. Training is described in more detail below in FIG. 4.

The system 200 can provide data identifying the selected gesture class as input to the mid-level agent neural network 124. In some implementations, the system 200 can also provide data identifying the selected gesture class as input to the low-level agent neural network.

The system 200 processes a mid-level input derived from the observation 214 using the mid-level agent neural network 124 to generate a mid-level output that includes parameters for the selected gesture class 210. The mid-level agent neural network 124 performs the sub-task of selecting a gesture, i.e., making a gesture selection 204, by specifying values of a set of gesture parameters 212.

Gesture parameters define a specific gesture and specify the information necessary to distinguish a gesture from other gestures in the same gesture class. That is, each gesture class has a corresponding set of parameters and values for the set of parameters uniquely define a gesture from the gesture class.

For example, for a tap gesture, the gesture parameters can include the location of the tap motion on the display of the computing device. For a swipe gesture, the gesture parameters can include the start and end locations of the swipe motion on the display of the computing device. For a fling gesture, the gesture parameters can include cardinal directions, such as north, northeast, east, southeast, south, southwest, west, and northwest, of the fling motion along a display of the computing device.

The mid-level agent neural network 124 receives data specifying the selected gesture class 210, an observation 214, and, optionally, the reward 208 as the mid-level input.

The mid-level agent neural network 124 processes the selected gesture class 210, observation 214, and, optionally, the reward 208 to generate a score for each possible value of each parameter for each gesture class.

In some implementations, the mid-level agent neural network 124 can process the observation 214 using an encoder neural network for each gesture class to generate a feature representation for each gesture class. For example, the encoder neural network can be a convolutional network. The mid-level agent neural network 124 can process each feature representation using a decoder neural network to generate a score for each possible value of each parameter for each gesture class. For example, the decoder neural network can be a multi-layer perceptron (MLP). For example, the score can be a value that estimates a return for each possible gesture.

The mid-level agent neural network 124 uses the selected gesture class 210 from the high-level agent to select a value for each of the parameters for the selected gesture class from the subset of scores corresponding to the selected gesture class. For example, the mid-level agent neural network 124 can select a value for each of the parameters where the value for each parameter has the highest score.

The mid-level agent neural network 124 can be trained on training data for the task that includes a gesture class 210, observation 214, and reward 208. Training is described in more detail below in FIG. 4.

The system 200 sends the mid-level output, i.e., data identifying the selected gesture 216 that can include gesture class 210 and gesture parameters 212, as input to the low-level agent neural network 126.

The system 200 processes a low-level input derived from at least the parameters 212 using a low-level agent neural network 126 to generate a policy output that defines a sequence of one or more actions. The low-level agent neural network 126 performs the sub-task of executing the gesture, i.e., performing a gesture execution 206. Executing a gesture involves determining a sequence of actions that will result in a gesture being performed that meets the gesture parameters.

The low-level agent neural network 126 receives data identifying the selected gesture 216 that includes the gesture class 210 and parameters 212 as a low-level input. The low-level agent neural network 126 can also receive a last touch position 218 on the display of a preceding action of a previous time step as part of the low-level input.

In some implementations, the low-level agent neural network 126 can include a separate network for each gesture class. The low-level agent neural network 126 can process the low-level input as a one-hot encoding of the last touch position 218 and a one-hot encoding of each parameter in parameters 212, and provide the one-hot encodings to the corresponding network for the gesture class. For example, one-hot encodings can be based on discretizations of the computing device screen, i.e., a 54 by 54 division of the screen, resulting in 2,916 possible screen sections for the last touch position and locations for the gesture parameters 212.

In some other implementations, the low-level agent neural network 126 can include one network that is shared between all gesture classes. The low-level agent neural network 126 can process the low-level input as a one-hot encoding of the last touch position 218, a one-hot encoding of each parameter in parameters 212, and a one-hot encoding of the gesture class 210.

In either of these implementations, the low-level agent neural network 126 can process the low-level input to generate a respective score for each potential action in a set of potential actions. The scores for each action can represent, e.g., a predicted return that would result from performing the action as part of the current gesture given the low-level input. As will be described below, the returns can be based on rewards that measure whether sequences of actions generated by the low-level agent neural network 126 accurately carry out gestures parametrized by the parameters 212 and the gesture class 210 specified in the inputs to the low-level agent neural network 126. The low-level agent neural network 126 can select an action by, e.g., selecting the potential action with a highest score or by sampling a potential action using the scores.

The low-level agent neural network 126 can continue selecting actions until a gesture corresponding to the set of parameters 212 that is provided as input to the low-level agent neural network 126 has been completed. To select an additional action given the actions that have already been selected, the neural network 126 can generate a new low-level input that includes the gesture class 210, parameters 212, and an updated last touch position 218 that corresponds to a position on the display of the most-recently selected action and process the new low-level input as described above to select the additional action.

After a given action has been selected, the low-level agent neural network 126 can determine whether the gesture has been completed in any of a variety of ways.

As one example, the low-level agent neural network 126 can continue selecting actions until a gesture detection algorithm indicates that the gesture has been completed as a result of the most recent sequence of selected actions. The gesture detection algorithm takes as input all the actions selected by the low-level agent neural network 126 as well as the gesture parameters selected by the mid-level agent neural network 124. For example, for a swipe gesture from location q₁ to location q₂, the gesture detection algorithm can maintain a sequence of all the actions the low-level agent neural network 126 selects. Whenever the gesture detection algorithm detects that the low-level agent neural network 126 has selected a lift action, the gesture detection algorithm looks at the sequence of actions starting from the previous lift action to the detected lift action. The gesture detection algorithm can determine that these are touch actions. Thus, the gesture detection algorithm can detect if a swipe gesture from location 91 to location q₂ is completed if the first of the sequence of touch actions is close to q₁ and the last of the sequence of touch actions is close to location q₂. In some implementations, each gesture can be defined as a GVF, described in more detail below in FIG. 4.

As another example, the low-level agent neural network 126 can include a termination prediction neural network that determines whether a gesture corresponding to a set of parameters has been completed. The input to the termination prediction neural network can include the gesture parameters selected by the mid-level agent neural network 124, and the set of actions selected by the low-level agent neural network 126 to complete the gesture selected by the mid-level agent neural network 124. After each action is selected, the termination prediction neural network determines whether the selected action and the actions preceding the selected action have completed the gesture. In some implementations, the termination prediction neural network is trained using supervised learning techniques. In other implementations, the termination prediction neural network can be trained to maximize a reward corresponding to completion criteria (e.g., the reward is equal to 1 when the gesture is completed, and equal to 0 otherwise).

In some implementations, the low-level agent neural network 126 includes a termination prediction neural network corresponding to each separate neural network for each gesture class. In other implementations, the low-level agent neural network 126 includes a termination prediction neural network corresponding to the network that is shared between all gesture classes.

As another example, the set of potential actions can include an action that corresponds to termination. In these cases, the low-level agent neural network 126 can select actions until the action that is selected is the termination action. The selection of the termination action in the policy output by the low-level agent neural network 126 indicates completion of the gesture.

The low-level agent neural network 126 can be trained using a gesture detection algorithm. Training is described in more detail below in FIG. 4. The reward 208 is not needed to train the low-level agent neural network 126 because the low-level agent neural network 126 learns sequences of actions that complete gestures, which is independent of the task.

Once a gesture is detected as completed, the system causes the sequence of actions to be performed. For example, the system can control an interaction system, such as the interaction system 104 of FIG. 1, to perform the sequence of actions. The system 200 sends the policy output, i.e., a selected sequence of actions 220 that execute the selected gesture, to the interaction system 104 that can interact with the computing device by carrying out the sequence of actions.

The system can perform the sub-tasks 202, 204, and 206 until termination criteria for the episode are satisfied, e.g., until the task has been successfully performed, until the computing device reaches a designated termination state, or until a maximum number of time steps have elapsed during the episode. In some implementations, the high-level agent 122 performing the sub-task 202 of making a gesture class selection can select the same gesture class that was performed at the previous time step. In other implementations, the system 200 can receive an observation and/or reward, and use a high-level agent neural network to perform the sub-task 202 of making a gesture class selection.

In some implementations, each agent neural network can be a distributed Deep Q-Network (DQN). That is, each score that each agent neural network generates can be a Q-value. The Q-value for an operation is an estimate of a return that would result from the agent neural network performing the operation in response to the current observation and thereafter selecting future operations performed by the agent neural network in accordance with current values of the parameters of the agent neural network. Each agent neural network can be trained to maximize a general value function (GVF). Training is described in more detail below with reference to FIG. 4.

FIG. 3 is a flow diagram of an example process 300 for performing a sequence of actions. For convenience, the process 300 will be described as being performed by a system of one or more computers located in one or more locations. For example, an action selection system, e.g., the action selection system 100 of FIG. 1, appropriately programmed in accordance with this specification, can perform the process 300.

The system can perform the process 300 at each time step during a sequence of time steps, e.g., at each time step during a task episode. The system continues performing the process 300 until termination criteria for the episode are satisfied, e.g., until the task has been successfully performed, until the computing device reaches a designated termination state, or until a maximum number of time steps have elapsed during the episode.

The system receives an observation characterizing a state of one or more computing devices at the time step (step 302). For example, the observation can be an image of a display of the one or more computing devices. In some implementations, the system can also receive a reward value that characterizes performance of the task as of the time step.

The system selects a gesture class using a high-level agent (step 306). For example, a gesture class can include a tap gesture class, a swipe gesture class, or a fling gesture class.

In some implementations, the system can select the gesture class that was determined to be a best performing gesture class for the task during training of the high-level agent. In these implementations, the system selects the same gesture class for every time step in the episode. The gesture class that the system selects at each time step after the first time step can depend on the gesture class that is selected at the first time step. For example, the system can select a gesture class at the first time step, and select the same gesture class for the remaining time steps in the episode. For example, during training, the high-level agent can learn a score mapping that maps each gesture class to a score that represents the average per time step reward for the task that was received when gestures from the gesture class were being performed during training episodes, and select the best performing gesture class to be the gesture class that maximizes the score. At the first time step, the system can select that gesture class for the episode.

In some other implementations, the high-level agent includes a high-level agent neural network. In these implementations, the system processes a high-level input derived from the observation to generate a high-level output that includes a score for each gesture class, and selects, using the high-level output, a gesture class from the plurality of gesture classes. In some implementations, the high-level input can also include the reward. For example, the system can select the gesture class that has the highest score among the gesture classes.

In some implementations, the system can use the high-level agent neural network to select a gesture class at the first time step, and select the same gesture class for the remaining time steps in the episode.

In some implementations, the system can use the high-level agent neural network to select a gesture class at each time step.

In other implementations, the system can use the high-level agent neural network to select a gesture class at regular intervals during the episode. The gesture class that the system selects at a given time step after the first time step in an interval can depend on the gesture class that is selected at the first time step in the interval. For example, the system can use the high-level agent neural network to select a gesture class at the first time step, and select the same gesture class for the next n time steps in the interval, where n is an integer greater than or equal to one. The system can use the high-level agent neural network to select a gesture class at the next time step after each interval.

In some implementations, the system can use the high-level agent neural network to select a gesture class whenever a criterion is satisfied. For example, the system can use a high-level agent neural network to select a gesture class at the first time step, and select the same gesture class for the remaining time steps in the episode until the criterion is satisfied. If the criterion is satisfied, the system can use the high-level agent neural network to select a new gesture class at the next time step.

The system processes a mid-level input derived from the observation using a mid-level agent neural network conditioned on the selected gesture class to generate a mid-level output that includes parameters that define a gesture from the selected gesture class (step 308). For example, parameters can include a location on the display for a tap gesture, the start and end locations of a swipe motion on the display for a swipe gesture, or a cardinal direction of a fling motion along the display for a fling gesture.

In some implementations, processing the mid-level input includes processing the observation using an encoder neural network for each gesture class to generate a feature representation for each gesture class, and processing each feature representation using a decoder neural network to generate a respective score for each of the parameters for each of the gesture classes. In some implementations, processing the mid-level input further includes generating the mid-level output by selecting, for the selected gesture class, a respective value for each of the parameters for the selected gesture class using the respective scores for each of the possible values for the parameter.

Processing the mid-level input is described in more detail above with reference to FIG. 2.

The system processes a low-level input derived from at least the parameters using a low-level agent neural network to generate a policy output that defines a sequence of one or more actions from a plurality of actions for interacting with the one or more computing devices (step 310). In some implementations, the low-level input further includes a touch position on a display of the one or more computing devices of a preceding action of a previous time step. In some implementations, the low-level input includes a one-hot encoding of each of the parameters and a one-hot encoding of the touch position on a display of the one or more computing devices of a preceding action of a previous time step.

An action is the most basic input on the computing device. For example, an action on a display of the computing device can include a touch input at a certain location on the display, or a lift motion at a certain location on the display. As another example, an action on a button of the computing device can include a press or release of the button. In some implementations, each action in the sequence includes a touch position on the display of the one or more computing devices.

In some implementations, the low-level agent neural network includes a neural network for each gesture class.

Processing the low-level input is described in more detail above with reference to FIG. 2.

The system performs the sequence of one or more actions to interact with the one or more computing devices (step 312). For example, the system can use the interaction system 104 of FIG. 1 to interact with the one or more computing devices.

FIG. 4 is a flow diagram of an example process 400 for training the high-level agent, mid-level agent neural network, and low-level agent neural network to control a computing device to perform a task. For convenience, the process 400 will be described as being performed by a system of one or more computers located in one or more locations. For example, a training system, e.g., the training system 190 of FIG. 1, appropriately programmed, can perform the process 400.

The agents and agent neural networks can be trained using any appropriate reinforcement learning technique, for example, a reinforcement learning technique using respective appropriate rewards. For example, the low-level agent neural network can be trained using rewards that measure whether a sequence of actions proposed by the low-level agent neural network results in a gesture being performed that matches the gesture parameters provided as input to the low-level agent neural network. The mid-level agent neural network and high-level agent can be trained using task rewards for the task.

In some implementations, each agent neural network can be trained to maximize a respective GVF. GVFs are associated with tuples (γ, C, π) where γ(s) is a continuation function, or a flexible state-dependent discounting scheme, that is greater than or equal to zero and less than or equal to one defined over all states S of a Markov Decision Process (MDP), C is a cumulant function over MDP transitions, and π is a policy that generates an action distribution for each MDP state. The corresponding value function is the expected return of a state following policy π:

$${υ}_{π , γ , C} ( s ) = 𝔼 [ {\sum }_{t = 0}^{∞} ( {\prod }_{i = 1}^{t} γ ( {S}_{i} ) ) {C}_{i} \vert {S}_{0} = s , {A}_{0 \cdot ∞} \sim π ]$$

where S₀=s is the initial state, and A is the action space.

For a prediction conditioned both on the initial state S₀=s and action A₀=a under the policy π, the expected return of an action a and state s can satisfy the following Bellman equation for the optimal return or Q-value:

$${q}_{γ , C}^{*} ( s , a ) = {\sum }_{{s}^{′} ∈ S} p ( {s}^{′} \vert s , a ) [ C ( s , a , {s}^{′} ) + γ ( s ) {max}_{{a}^{′}} {q}_{γ , C}^{*} ( {s}^{′} , {a}^{′} ) ]$$

For any state-action pair (s, a), the optimal Q-value represents the maximum discounted return or score that can be achieved when the agent interacts with the computing system from state s starting with action a. The action at each level of the hierarchy can be defined differently. For example, the system can use the options framework for temporally extended actions. Temporal abstraction can be achieved through the use of options. An option is composed of an initialization function, which defines the states where an option can be initiated, a policy or an action selection scheme, and a termination function, which determines when the execution of an option is terminated. Every GVF can be associated with an option by allowing option initialization in every state, using the policy as an action selection, and using a continuation as the opposite of termination, i.e., the option terminates with a probability of I—(probability of continuation).

The temporally extended action for a high-level agent neural network is a gesture class. The temporally extended action for the mid-level agent neural network is a gesture with parameters. The action for the low-level agent neural network is a touch or lift at a location on the display of the computing device.

The system can train the high-level agent, mid-level agent neural network, and low-level agent neural network so that a learning rate for each agent or agent neural network is set to a non-zero learning rate for a single level at a time. For example, as will be described below, the system can train the low-level agent neural network prior to the training of the high-level agent and mid-level agent neural network, or train the mid-level agent neural network prior to training the high-level agent.

The system can pre-train the low-level agent neural network prior to the training of the high-level agent and mid-level agent neural network (step 402). To train the low-level agent neural network, the system concatenates one-hot encodings for the gesture parameters and a last touch position. During training, the low-level agent neural network can use the gesture detection algorithm, described above with reference to FIG. 2, to determine if a gesture has been completed. The gesture detection algorithm can send a signal to the low-level agent neural network indicating the completion of the gesture. The system can train the low-level agent neural network using random gesture classes and gesture parameters. The system can train each class of gestures separately so that the low-level agent neural network includes separate networks for each gesture class. For example, the system can train a separate termination prediction neural network for taps, swipes, and flings. The system can also apply Hindsight Experience Replay (HER) for improved data efficiency.

In some implementations, where the low-level agent neural network includes one network that is shared between all gesture classes, the system can concatenate one-hot encodings for the gesture class, gesture parameters, and last touch position.

Each possible gesture can be defined by its own value function. For example, the low-level agent neural network can define a value function for each possible swipe gesture, tap gesture, and fling gesture.

The system can train the low-level agent neural network using a gesture detection algorithm that indicates whether a gesture has been completed. For example, to capture a swipe gesture between two locations on a display, the cumulant and continuation functions are based on the positions on the display in between the two locations. The low-level agent neural network maintains a sequence of all touch or lift positions in a gesture, denoted by (p₀, p₁, . . . , pₜ) where pᵢ is a position on a display for a touch action, or pᵢ=0 for a lift action. For example, to capture a swipe gesture from location q₁ to q₂, the cumulant can be defined as:

$${c}_{{q}_{1} , {q}_{2}} ( {p}_{0} , {p}_{1} … , {p}_{t} ) = \{ \begin{matrix}1 & if ∃ i < t with [ {p}_{i} , {p}_{i + 1} , … , {p}_{t - 1} , {p}_{t} ] = [ 0 , {q}_{1} , {p}_{i + 2} , … , {p}_{t - 2} , {q}_{2} , 0 ] and {p}_{j} \neq 0 , ∀ i < j < t , \\ 0 & otherwise .\end{matrix}$$

The continuation function can be defined as:

$${γ}_{{q}_{1} , {q}_{2}} = 1 - {C}_{{q}_{1} , {q}_{2}}$$

The system can thus train the low-level agent neural network to optimize a return or Q-value, which is based on the cumulant and continuation functions.

The system can train the high-level agent and the mid-level agent neural network through reinforcement learning on training data for the task. In some implementations, the system trains the mid-level agent neural network (step 406) prior to training the high-level agent (step 408). In these implementations, the system trains the mid-level agent neural network using randomly chosen gesture classes and then trains the high-level agent while holding the mid-level and low-level agent neural networks fixed.

In some implementations, the system trains the mid-level agent neural network jointly with the high-level agent (step 410). In these implementations, the system trains the high-level agent and mid-level neural network jointly while holding the low-level neural network fixed.

In some implementations, the system can train the high-level agent before the mid-level and low-level agent neural networks have finished training, or jointly with the mid-level and low-level agent neural networks. For example, the system can use the high-level agent to determine which gesture classes perform well for the task, and train the mid-level and low-level agent neural networks only for those gesture classes.

The high-level agent can learn a score mapping that maps each gesture class to a score. To train the high-level agent and learn the score mapping, the system can use a reward value to learn a score for each gesture class that represents the average per time step reward for the task. The high-level agent can determine a best performing gesture class for the task to be the gesture class that maximizes the score in the score mapping.

In some implementations, the high-level agent can include a high-level agent neural network. In these implementations, the system can train the high-level agent neural network on training data that includes rewards to predict a score that represents a return for the task for a gesture class at a time step. In some implementations, the high-level agent neural network can be trained on training data for the task that also includes observations.

The system can train the mid-level agent neural network on training data that includes observations, rewards, and gesture class to predict a score that represents a return for the task for each possible value of each parameter of a gesture at a time step.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method for controlling one or more computing devices to perform a task, the method comprising, at each of a plurality of time steps:
receiving an observation characterizing a state of the one or more computing devices at the time step;
selecting a gesture class for the time step from a plurality of gesture classes using a high-level agent;
processing a mid-level input derived from the observation using a mid-level agent neural network conditioned on the selected gesture class to generate a mid-level output that comprises parameters that define a gesture from the selected gesture class;
processing a low-level input derived from at least the parameters using a low-level agent neural network to generate a policy output that defines a sequence of one or more actions from a plurality of actions for interacting with the one or more computing devices; and
performing the sequence of one or more actions to interact with the one or more computing devices.

2. The method of claim 1, wherein selecting a gesture class for the time step from a plurality of gesture classes using a high-level agent comprises:
selecting, from the plurality of gesture classes, a gesture class that was determined to be a best performing gesture class for the task during training of the high-level agent.

3. The method of claim 1, wherein the high-level agent comprises a high-level agent neural network, and wherein selecting a gesture class for the time step from a plurality of gesture classes using a high-level agent comprises:
processing a high-level input derived from the observation using the high-level agent neural network to generate a high-level output that comprises a respective score for each gesture class of the plurality of gesture classes; and
selecting, using the high-level output, a gesture class from the plurality of gesture classes.

4. The method of claim 1, wherein the plurality of gesture classes includes one or more of: a tap gesture class, a swipe gesture class, or a fling gesture class.

5. The method of claim 1, wherein the observation is an image of a display of the one or more computing devices.

6. The method of claim 1, wherein the action is a touch input to a display of the one or more computing devices.

7. The method of claim 1, wherein the parameters that define a gesture from the selected gesture class comprise at least one touch position on a display of the one or more computing devices.

8. The method of claim 1, wherein the parameters that define a gesture from the selected gesture class comprise a cardinal direction along a display of the one or more computing devices of a motion corresponding to the gesture.

9. The method of claim 1, wherein the low-level input further comprises a touch position on a display of the one or more computing devices of a preceding action of a previous time step.

10. The method of claim 9, wherein the low-level input comprises a one-hot encoding of each of the parameters and a one-hot encoding of the touch position on a display of the one or more computing devices of a preceding action of a previous time step.

11. The method of claim 1, wherein each action in the sequence comprises a touch position on a display of the one or more computing devices.

12. The method of claim 1, wherein the mid-level agent neural network is configured to process the mid-level input derived from the observation, and wherein processing the mid-level input comprises:
processing the observation using an encoder neural network for each gesture class to generate a feature representation for each gesture class; and
processing each feature representation using a decoder neural network to generate a respective score for each of the parameters for each of the gesture classes.

13. The method of claim 1, wherein each gesture class of the plurality of gesture classes has a respective set of parameters that each have a respective set of possible values, wherein the mid-level agent neural network is configured to process the mid-level input to generate a respective score for each possible value of each of the parameters for each of the gesture classes, and wherein processing the mid-level input comprises:
generating the mid-level output by selecting, for the selected gesture class, a respective value for each of the parameters for the selected gesture class using the respective scores for each of the possible values for the parameter.

14. The method of claim 1, wherein the low-level agent neural network comprises a respective neural network for each gesture class.

15. The method of claim 1, wherein the high-level agent and the mid-level agent neural network have been trained through reinforcement learning on training data for the task.

16. The method of claim 15, wherein the low-level agent neural network has been pre-trained prior to the training of the high-level agent and mid-level agent neural network.

17. The method of claim 15, wherein the mid-level agent neural network has been trained prior to the training of the high-level agent.

18. The method of claim 15, wherein the mid-level agent neural network has been trained using randomly chosen gesture classes.

19. The method of claim 15, wherein the mid-level agent neural network has been trained jointly with the high-level agent.

20. A system comprising one or more computers and one or more storage devices storing instructions that when executed by the one or more computers cause the one or more computers to perform operations comprising, at each of a plurality of time steps:
receiving an observation characterizing a state of the one or more computing devices at the time step;
selecting a gesture class for the time step from a plurality of gesture classes using a high-level agent;
processing a mid-level input derived from the observation using a mid-level agent neural network conditioned on the selected gesture class to generate a mid-level output that comprises parameters that define a gesture from the selected gesture class;
processing a low-level input derived from at least the parameters using a low-level agent neural network to generate a policy output that defines a sequence of one or more actions from a plurality of actions for interacting with the one or more computing devices; and
performing the sequence of one or more actions to interact with the one or more computing devices.
